(19) United States
(12) Patent Application Publication
(10) Pub. No.: US 2009/0011261 A1
(43) Pub. Date: Jan. 8, 2009

(54) METHOD FOR MANUFACTURING DISPLAY APPARATUS

(75) Inventor: Hiroshi GOTOU, Kobe-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd.), Kobe-shi (JP)

(21) Appl. No.: 12/131,444

(22) Filed: Jun. 2, 2008

(30) Foreign Application Priority Data
Jun. 26, 2007 (JP) 2007-168286

(51) Int. Cl. B05D 5/12; B32B 15/20

(52) U.S. Cl. 428/469; 427/123

(57) ABSTRACT

There is provided a direct contact technology whereby the contact electric resistance between an Al alloy film and transparent oxide conductives can be reduced, the heat resistance is also excellent, and hence the Al alloy film can be in direct contact with the transparent oxide conductives, and further the electric resistivity of the Al alloy is also still more reduced, and the productivity is also more enhanced. There is provided a method for manufacturing a display apparatus having a structure in which a transparent oxide conductive film and an Al alloy film are in direct contact with each other on a substrate. The Al alloy film contains at least one alloy element selected from a group consisting of Ag, Zn, Cu, and Ni in an amount of 0.5 atomic percent or less. The temperature of the substrate is controlled to the precipitation temperature of the alloy element or higher, and the Al alloy film is formed.

### BACKGROUND OF THE INVENTION

1. Field of the Invention

The present invention relates to a method for manufacturing a display apparatus. More particularly, it relates to a method for manufacturing a display apparatus having a structure in which a transparent oxide conductive film and an Al alloy film are in direct contact with each other on a substrate.

2. Description of the Related Art

Al alloys have found use as thin film materials of wiring films, electrode films, and reflection electrode films, and the like in the field of slim flat panel display (FPD) apparatuses such as liquid crystal display apparatuses, plasma display apparatuses, electroluminescence display apparatuses, and field emission display apparatuses because of their low electric resistivity and easy workability, and other reasons.

For example, an active matrix type liquid crystal panel includes a TFT substrate having thin film transistors (TFT's) which are switching elements, pixel electrodes including a transparent oxide conductive film, and a wiring part including scanning lines and signal lines. For the wiring materials forming the scanning lines or signal lines, generally, pure Al and Al—Nd alloy thin films are used. However, when various electrode parts formed with these thin films are brought in direct contact with pixel electrodes, insulating aluminum oxide or the like is formed at the interface, resulting in an increase in contact electric resistance. For this reason, heretofore, a barrier metal layer including a refractory metal such as Mo, Cr, Ti, or W is provided between the wiring material of Al and the pixel electrodes. This results in reduction of the contact electric resistance.

However, the method in which a barrier metal layer is provided as described above involves complicated manufacturing steps. This unfavorably incurs an increase in production cost.

Under such circumstances, there have been studied technologies capable of omitting the formation of the barrier metal layer, and capable of bringing the Al alloy film into direct contact with transparent pixel electrodes (which may be hereinafter generically referred to as direct contact technologies). The direct contact technology requires low contact electric resistance between the Al alloy film which is an electrode material and transparent pixel electrodes and excellent heat resistance so as to obtain high display-quality display apparatus.

The present applicant also proposes the method described in Japanese Unexamined Patent Application Publication (JP-A) No. 2004-214606 as the direct contact technology. JP-A-2004-214606 discloses a wiring material of an Al alloy film containing at least one alloy element in an amount of 0.1 to 6 atomic percent selected from a group consisting of Au, Ag, Zn, Cu, Ni, Sr, Ge, Sm, and Bi. When the Al alloy film is used, an electrically conductive alloy element-containing precipitate is formed at the interface between the Al alloy film and transparent pixel electrodes. This inhibits the formation of an insulating material such as aluminum oxide, which can reduce the contact electric resistance. Whereas, when the amount of the alloy element added falls within the foregoing range, the electric resistivity of the Al alloy itself can also be controlled low. Further, when to the Al alloy film, at least one alloy element of Nd, Y, Fe, and Co is further added, the formation of hillock (nodular projections) is inhibited. This results in an improvement of the heat resistance. The precipitate of the alloy element can be obtained in the following manner. On a substrate, an Al alloy film is deposited by a sputtering method or the like. Then, the resulting film is subjected to a heating (annealing) treatment at 150 to 400° C. (preferably 200 to 350° C.) for about 15 minutes to 1 hour.

With the method of JP-A-2004-214606, there can be obtained a display apparatus which is high in response speed, has high display quality, and is low in power consumption.

In recent years, there has been a growing demand for further improvements of the power consumption, the response speed, and the like, and the improvement of the productivity from users' side. The method described in the JP-A-2004-214606 is very useful as the direct contact technology. However, in order to desired effects, a prescribed heat treatment (subsequent heat treatment) must be separately carried out after deposition of an Al alloy film on a substrate. Accordingly simplification of the process is required. Further, a further reduction of the electric resistivity of the Al alloy itself is also required.

In this specification, as in the JP-A-2004-214606, the heat treatment to be carried out after deposition of an Al alloy film on a substrate for obtaining an alloy element-containing precipitate may be referred to as a “post heat treatment”.

### SUMMARY OF THE INVENTION

The present invention was made in view of the foregoing circumstances. It is an object of the present invention to provide a novel direct contact technology whereby the contact electric resistance between an Al alloy film and transparent pixel electrodes can be reduced, and the heat resistance is excellent, so that the Al alloy film can be brought in direct contact with the transparent pixel electrodes, and further, the electric resistivity of the Al alloy is further reduced, and the productivity is more enhanced.

A method for manufacturing a display apparatus in accordance with the present invention which can solve the foregoing problem is a method for manufacturing a display apparatus having a structure in which a transparent oxide conductive film and an Al alloy film are in direct contact with each other on a substrate. The gist of the method resides in that the Al alloy film contains at least one alloy element selected from a group consisting of Ag, Zn, Cu, and Ni in an amount of 0.5 atomic percent or less, and that the method includes: controlling the temperature of the substrate to the precipitation temperature of the alloy element or higher, and forming the Al alloy film.

In a preferred embodiment, the alloy element is Ni, and the temperature of the substrate is 250° C. or higher.

In accordance with an aspect of the invention, there is also provided a display apparatus including: a substrate; a transparent oxide conductive film; and an Al alloy film, the transparent oxide conductive film being in direct contact with the Al alloy film on the substrate. In the display apparatus, the Al alloy film contains at least one alloy element selected from a group consisting of Ag, Zn, Cu, and Ni in an amount of 0.5 atomic percent or less, and when the variance of the contact electric resistance between the transparent oxide conductive film and the Al alloy film is approximated by the Gaussian distribution based on 100 samples obtained from the display apparatus, the variance coefficient σ is 0.5 or less.

In a preferred embodiment, the Al alloy film is a component of a scanning line of a thin film transistor.

In a preferred embodiment, the Al alloy film is a component of a drain electrode of a thin film transistor.

With the manufacturing method of the present invention, it is not necessary to carry out a prescribed heat treatment (a post heat treatment for obtaining a precipitate of the alloy element, useful for allowing the function of the present invention to be exerted) after deposition of an Al alloy film on a substrate as in the JP-A-2004-214606. This can omit the independent process for the “post heat treatment”.

Whereas, the present invention can provide a display apparatus in which an Al alloy film can be in direct contact with the transparent pixel electrodes including a transparent oxide conductive film without a barrier metal layer interposed therebetween, and which is low in the contact electric resistance between the Al alloy film and the transparent pixel electrodes, has also been enhanced in the heat resistance, and has also been reduced in the electric resistivity of the Al alloy. Further, in accordance with the present invention, it is possible to remarkably control the variations in the contact electric resistance among samples obtained from the display apparatus.

Therefore, the manufacturing method of the present invention is excellent in productivity and is very useful as a direct contact technology capable of providing a display apparatus which is much higher in display potential.

### BRIEF DESCRIPTION OF THE DRAWINGS

FIG. 1 is a view showing a Kelvin pattern (TEG pattern) for use in a measurement of the contact electric resistivity between an Al alloy film and a transparent oxide conductive film (ITO film);

FIG. 2 is a schematic cross sectional explanatory view showing a configuration of a conventional typical amorphous silicon TFT substrate;

FIG. 3 is a schematic cross sectional explanatory view showing a configuration of a TFT substrate in accordance with a first embodiment of the present invention;

FIG. 4 is an explanatory view showing, step by step, one example of a manufacturing step of the TFT substrate shown in FIG. 3;

FIG. 5 is an explanatory view showing, step by step, one example of a manufacturing step of the TFT substrate shown in FIG. 3;

FIG. 6 is an explanatory view showing, step by step, one example of a manufacturing step of the TFT substrate shown in FIG. 3;

FIG. 7 is an explanatory view showing, step by step, one example of a manufacturing step of the TFT substrate shown in FIG. 3;

FIG. 8 is an explanatory view showing, step by step, one example of a manufacturing step of the TFT substrate shown in FIG. 3;

FIG. 9 is an explanatory view showing, step by step, one example of a manufacturing step of the TFT substrate shown in FIG. 3;

FIG. 10 is an explanatory view showing, step by step, one example of a manufacturing step of the TFT substrate shown in FIG. 3;

FIG. 11 is an explanatory view showing, step by step, one example of a manufacturing step of the TFT substrate shown in FIG. 3;

FIG. 12 is a schematic cross sectional explanatory view showing a configuration of a TFT substrate in accordance with a second embodiment of the present invention;

FIG. 13 is an explanatory view showing, step by step, one example of a manufacturing step of the TFT substrate shown in FIG. 12;

FIG. 14 is an explanatory view showing, step by step, one example of a manufacturing step of the TFT substrate shown in FIG. 12;

FIG. 15 is an explanatory view showing, step by step, one example of a manufacturing step of the TFT substrate shown in FIG. 12;

FIG. 16 is an explanatory view showing, step by step, one example of a manufacturing step of the TFT substrate shown in FIG. 12;

FIG. 17 is an explanatory view showing, step by step, one example of a manufacturing step of the TFT substrate shown in FIG. 12;

FIG. 18 is an explanatory view showing, step by step, one example of a manufacturing step of the TFT substrate shown in FIG. 12;

FIG. 19 is an explanatory view showing, step by step, one example of a manufacturing step of the TFT substrate shown in FIG. 12;

FIG. 20 is Gaussian distribution (normal distribution) curves of the contact electric resistances of an inventive sample manufactured by using an Al-0.5 atomic percent Ni alloy in Example 1 and a reference sample; and

FIG. 21 is a schematic cross sectional enlarged explanatory view showing a configuration of a typical liquid crystal display apparatus to which the amorphous silicon TFT substrate is applied.

### DESCRIPTION OF THE PREFERRED EMBODIMENTS

The present inventors have conducted a continuous study on the direct contact technology described in the JP-A-2004-214606, particularly, aiming at a further improvement of the productivity and a further reduction of the electric resistivity. Specifically, they have conducted a study for providing a direct contact technology capable of omitting the “post heat treatment” for obtaining a precipitate of the alloy element (which may be hereinafter simply referred to as a “precipitate”) in the method described in JP-A-2004-214606, and capable of further reducing the electric resistivity of the Al alloy.

As a result, they found the following: (i) Not by performing a heat treatment after deposition of an Al alloy film on a substrate as in the JP-A-2004-214606, but by depositing an Al alloy film after controlling the temperature of a substrate to the precipitation temperature of the alloy element or higher, it is possible to omit the “post heat treatment” after deposition. This enhances the productivity; (ii) Further, in accordance with the present invention, the amount of alloy elements to be added to Al is controlled lower as compared with the method of the JP-A-2004-214606 (upper limit 0.5 atomic percent). This further reduces the electric resistivity of the Al alloy, and promotes the effect of reduction of the power consumption and the effect of improvement of the response speed; and (iii) By the use of the manufacturing method of a display apparatus including such an Al alloy film formation step, the variations in contact electric resistance of the display apparatus can be controlled sufficiently low. Consequently, the present invention was completed.

Herein, a more detailed description will be given to the relationship between the amount of alloy elements to be added to the Al alloy film and the variations in electric resistivity and contact electric resistance of the Al alloy.

In general, when an alloy element such as Ni is added to Al, there is observed a tendency that as the alloy element content increases, the electric resistivity of the Al alloy also increases. An increase in electric resistivity incurs an increase in power consumption or a signal delay (delay of the response speed). Therefore, the following is expectable to a certain degree. When the upper limit of the amount of an alloy element to be added is set as low as 0.5 atomic percent as in the present invention as compared with the case of the JP-A-2004-214606 (the upper limit of the amount of an alloy element to be added, 6 atomic percent), the electric resistivity of the Al alloy is also reduced.

However, the study by the present inventors proved the following. When the upper limit of the amount of the alloy element to be added is controlled as remarkably low as 0.5 atomic percent, the electric resistivity of the Al alloy is reduced. On the other hand, variations in contact electric resistance among samples obtained from the display apparatus having the Al alloy film increase (see Examples described later). This is a problem not recognized in the related art including the JP-A-2004-214606.

The present invention is very useful in the following point. Not only the problem to be solved in the related art, “further reduction of the electric resistivity of the Al alloy and omission of a process such as a post heat treatment” can be solved, but also a problem not recognized heretofore, i.e., a new problem (control of variations in contact electric resistance) due to the remarkably low controlled amount of an alloy element added.

Below, the manufacturing method of the present invention will be described in details.

The manufacturing method of the present invention is a method for manufacturing a display apparatus having a structure in which a transparent oxide conductive film and an Al alloy film are in direct contact with each other on a substrate. The Al alloy film contains at least one alloy element selected from a group consisting of Ag, Zn, Cu, and Ni in an amount of 0.5 atomic percent or less. The temperature of the substrate is controlled to the precipitation temperature of the alloy element or higher, and the Al alloy film is formed.

Below, the Al alloy film described above may be simply abbreviated as an “Al alloy film”.

The gist of the present invention resides in the following: as described above, for depositing an Al alloy film on a substrate, the temperature of the substrate is increased to the precipitation temperature of the alloy element or higher. In this manner, the substrate temperature is previously increased to a prescribed temperature or higher, and then, an Al alloy film is formed. Then, even when the “post heat treatment” after deposition described in the JP-A-2004-214606 is omitted, the same precipitate as in the JP-A-2004-214606 can be obtained. Therefore, with the method of the present invention, the productivity can be enhanced as compared with the JP-A-2004-214606. In addition, the electric resistivity of the Al alloy can be reduced by the reduction of the alloy element content, and further, variations in contact electric resistance can also be remarkably controlled.

In this specification, the term “precipitation temperature of the alloy element” denotes the temperature range in which the electric resistivity is sharply reduced when the Al alloy film is measured for the electric resistivity after having been applied with heat history. Specifically, the term “precipitation temperature of the alloy element” denotes the temperature range in which the electric resistivity is sharply reduced where the electric resistivity is obtained in the following manner. When the Al alloy film containing alloy elements (Ag, Zn, Cu, and Ni) defined in the present invention is heated within the temperature range of 100 to 300° C. for 30 minutes. Then, the sheet resistance is measured with a four-probe method using a pattern with a wiring width of 100 μm and a wiring length of 1000 μm, and converted into electric resistivity.

The precipitation temperature of the alloy element shows a given value for every kind of an element to be added to Al as a base metal. With an increase in amount of the alloy element added, the precipitation temperature is constant, but the electric resistivity after precipitation is higher as compared with the one having a low alloy element content.

Table 1 shows the precipitation temperature of each alloy element when an Al alloy film containing an alloy element (Ag, Zn, Cu, or Ni) in an amount of 0.5 atomic percent is used. Further, the precipitation temperature of each alloy element in an Al alloy film (the amount of the alloy element added=2.0 atomic percent, 0.3 atomic percent, 0.2 atomic percent, and 0.1 atomic percent) used in Examples is as follows.

TABLE 1

| Alloy Element | Precipitation Temperature (° C.) |
|---|---|
| Ag | 150-200 |
| Zn | 200-250 |
| Cu | 150-200 |
| Ni | 200-250 |

In the present invention, when an Al alloy film containing an alloy element in an amount of 0.5 atomic percent is used, the temperature of the substrate is controlled to the precipitation temperature of the alloy element shown in Table 1 (at least the temperature within the range of the precipitation temperatures shown in Table 1, or higher) or higher. Then, the Al alloy film is deposited. From the viewpoints of ease of process or apparatus control, avoidance of hillock formation, and the like, the substrate temperature is preferably as low as possible. Incidentally, the upper limit of the substrate temperature is mainly determined by the relationship with the heat treatment temperature in the manufacturing step of a display apparatus. The upper limit of the heat treatment temperature is preferably set at generally the upper limit of the substrate temperature.

Specifically, the preferred substrate temperature when Ni is used as an alloy element is generally 250° C. or more to 300° C. or less. The preferred substrate temperature when Ag is used is generally 200° C. or more to 250° C. or less. The preferred substrate temperature when Cu is used is generally 200° C. or more to 250° C. or less. The preferred substrate temperature when Zn is used is generally 250° C. or more to 300° C. or less.

In the present invention, the temperature of the entire substrate is preferably controlled so as to fall within the foregoing range. Therefore, when the substrate temperature is desired to be controlled to 200° C., the temperature is preferably held at 200° C. during the deposition step so that the temperature of the entire substrate is 200° C. or more.

The largest feature of the deposition method of an Al alloy film in accordance with the present invention resides in that the substrate temperature is controlled in the foregoing manner. Other deposition steps than the foregoing have no particular restriction. Commonly employed means can be adopted.

As the deposition method of an Al alloy film, mention may be typically made of a sputtering method using a sputtering target. The sputtering method is a method for manufacturing a thin film in the following manner. A plasma discharge is formed between a substrate and a sputtering target (target material) formed from the same material as that of the thin film to be formed. Thus, a gas ionized by the plasma discharge is caused to collide with the target material. As a result, the atoms of the target material are knocked out to be deposited on the substrate. As distinct from a vacuum deposition method or an arc ion plating (AIP) method, the sputtering method has a merit of capable of forming a thin film of the same composition as that of the target material. Particularly, the Al alloy film deposited by a sputtering method has advantages of capable of solving alloy elements such as Nd not soluble in a solid solution form in equilibrium, and exhibiting excellent performances as a thin film, and other advantages. However, the present invention is not limited to the foregoing. Thus, methods commonly employed for the deposition method of an Al alloy film can be appropriately adopted.

The Al alloy film for use in the present invention contains at least one selected from a group consisting of Ag, Zn, Cu, and Ni as an alloy element in an amount of 0.5 atomic percent or less. These elements are particularly useful for reducing the contact electric resistance between the Al alloy film and transparent pixel electrodes. These may be added alone, or in combination of two or more thereof.

Out of these, Ni is very excellent in function of reducing the contact electric resistance. For this reason, the Al alloy film for use in the present invention preferably contains at least Ni as an alloy element.

In order to allow the function by the alloy element to be effectively exerted, a total content of Ni, Ag, Cu, and Zn affecting the contactability out of alloy elements is set at preferably 0.1 atomic percent or more, and more preferably 0.2 atomic percent or more. However, with an increase in content of the alloy elements, the electric resistivity of the Al alloy increases. Therefore, in the present invention, the upper limit is set at 0.5 atomic percent. From the viewpoint of reduction of the electric resistivity of the Al alloy, the content of the alloy elements is preferably lower. The preferred content of the alloy elements can be appropriately determined by the balance between reduction of the contact electric resistance and reduction of the electric resistivity of the Al alloy.

The Al alloy film for use in the present invention may contain, other than the alloy element (at least one of Ag, Zn, Cu, and Ni) described above, a heat resistance improving element described in JP-A-2004-214606 (at least one of Nd, Y, Fe, and Co). Whereas, other heat resistance improving elements (e.g., at least one of Ti, V, Zr, Nb, Mo, Hf, Ta, and W, and at least one of Mg, Cr, Mn, Ru, Rh, Pd, Ir, Pt, La, Gd, Tb, and Dy) may be added. Alternatively, at least one of Sr, Sm, Ge, and Bi may be added. It has been separately confirmed experimentally that even further addition of these alloy elements provides the operational advantage of the present invention.

The Al alloy film for use in the present invention is applicable as a wiring material for source-drain electrodes or a material for a reflection film.

The present invention also includes a display apparatus having a structure in which the Al alloy film and a transparent oxide conductive film are in direct contact with each other. With the display apparatus of the present invention, when the variance (σ) of the contact electric resistance between the transparent oxide conductive film and the Al alloy film is approximated based on 100 samples obtained from the display apparatus by the Gaussian distribution expressed by the following formula f(x), the variance coefficient σ satisfies 0.5 or less. Namely, the present invention can provide a display apparatus of which the variation in variance among samples fall within a remarkably narrow range.

$$\begin{matrix}[ Mathematical Expression 1 ] & \\ f ( x ) = \frac{1}{\sqrt{2 π} σ} exp ( - \frac{{( x - μ )}^{2}}{2 {σ}^{2}} ) & ( 1 )\end{matrix}$$

where μ represents the average value of contact electric resistances

Below, by reference to the accompanying drawings, preferred embodiments of a TFT substrate in accordance with the present invention will be described. Below, a description will be given by taking a liquid crystal display apparatus including an amorphous silicon TFT substrate or a polysilicon TFT substrate as a typical example. However, the present invention is not limited thereto. The present invention is capable of being practiced with changes properly made within the range applicable to the foregoing and following gists. All of them are included in the technical scope of the present invention. It has been experimentally confirmed that the Al alloy film for use in the present invention is also similarly applicable to, for example, reflection electrodes or TAB connection electrodes to be used for signal input and output to the outside in a reflection type liquid crystal display apparatus, or the like.

### Embodiment 1

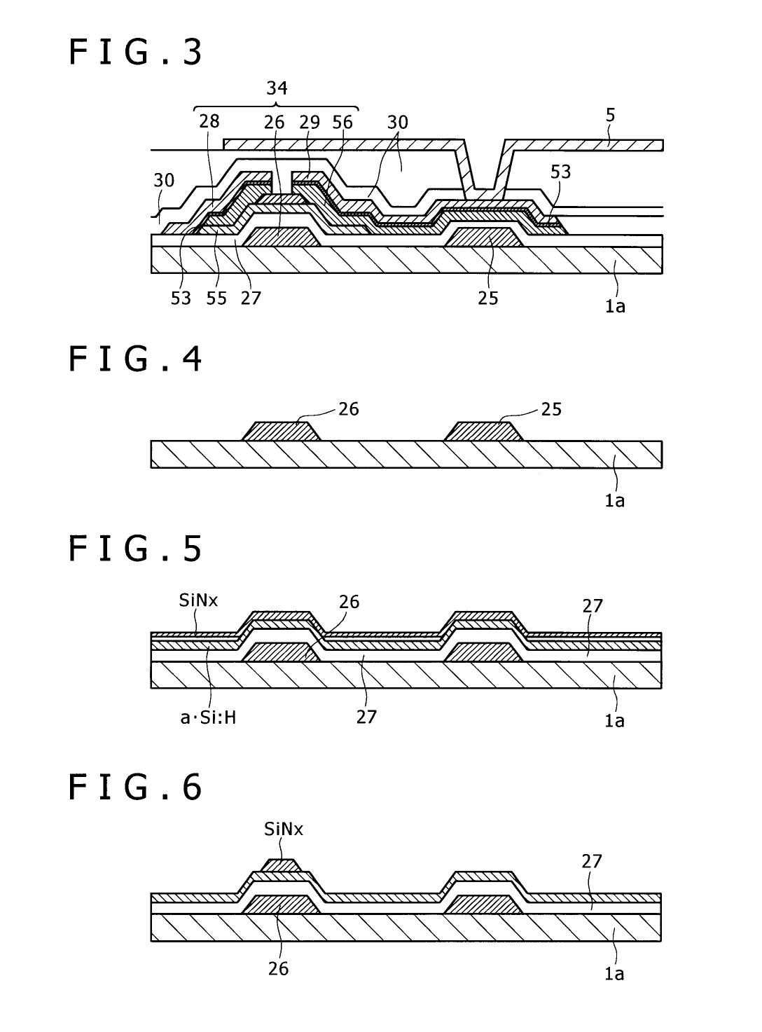

By reference to FIG. 3, an embodiment of an amorphous silicon TFT substrate will be described.

FIG. 3 is a schematic cross sectional explanatory view illustrating a preferred embodiment of a bottom gate type TFT substrate in accordance with the present invention. For reference, a schematic cross sectional explanatory view of a conventional typical amorphous silicon TFT substrate is attached as FIG. 2.

As shown in FIG. 2, in a conventional TFT substrate, on a scanning line 25, on a gate electrode 26, and on or under a source-drain wiring 34, barrier metal layers 51, 52, 53, and 54 are formed, respectively. In contrast, in the TFT substrate of this embodiment, the barrier metal layers 51, 52, and 54 can be omitted. Namely, in accordance with this embodiment, without a barrier metal layer interposed as in the related art, the wiring material for use in a source-drain electrode 29 can be brought in direct contact with a transparent pixel electrode 5. This can also implement favorable TFT characteristics comparable to or better than those of the conventional TFT substrate.

Then, by reference to FIGS. 4 to 11, a description will be given to one example of a method for manufacturing an amorphous silicon TFT substrate in accordance with the present invention shown in FIG. 3. Herein, as a typical material for use in a source-drain electrode and a wiring thereof, an Al-0.5 atomic percent Ni-0.35 atomic percent La alloy is used. As a typical material for use in a gate electrode and a wiring thereof, an Al-0.5 atomic percent Ni-0.35 atomic percent La alloy is used. However, the invention is not limited thereto. The thin film transistor is an amorphous silicon TFT using a hydrogenated amorphous silicon as a semiconductor layer. Throughout FIGS. 4 to 11, the same reference numerals and signs as in FIG. 3 are given.

First, on a glass substrate (transparent substrate) 1a, an Al-0.5 atomic percent Ni-0.35 atomic percent La alloy film with a thickness of about 200 nm is deposited by using a sputtering method. The deposition temperature of sputtering is set at 250° C. This film is patterned, thereby to form a gate electrode 26 and a scanning line 25 (see FIG. 4). At this step, the periphery of the lamination thin film is preferably etched in an about 30° to 40° taper so as to enhance the coverage of a gate insulation film 27 in FIG. 5 described later.

Then, as shown in FIG. 5, by using a method such as a plasma CVD method, the gate insulation film 27 is formed with a silicon nitride film (SiNx) with a thickness of about 300 nm. The deposition temperature of the plasma CVD method is set at about 350° C. Subsequently, by using a method such as a plasma CVD method, on the gate insulation film 27, a hydrogenated amorphous silicon film (αSi—H) 55 with a thickness of about 50 nm and a silicon nitride film (SiNx) with a thickness of about 300 nm are deposited.

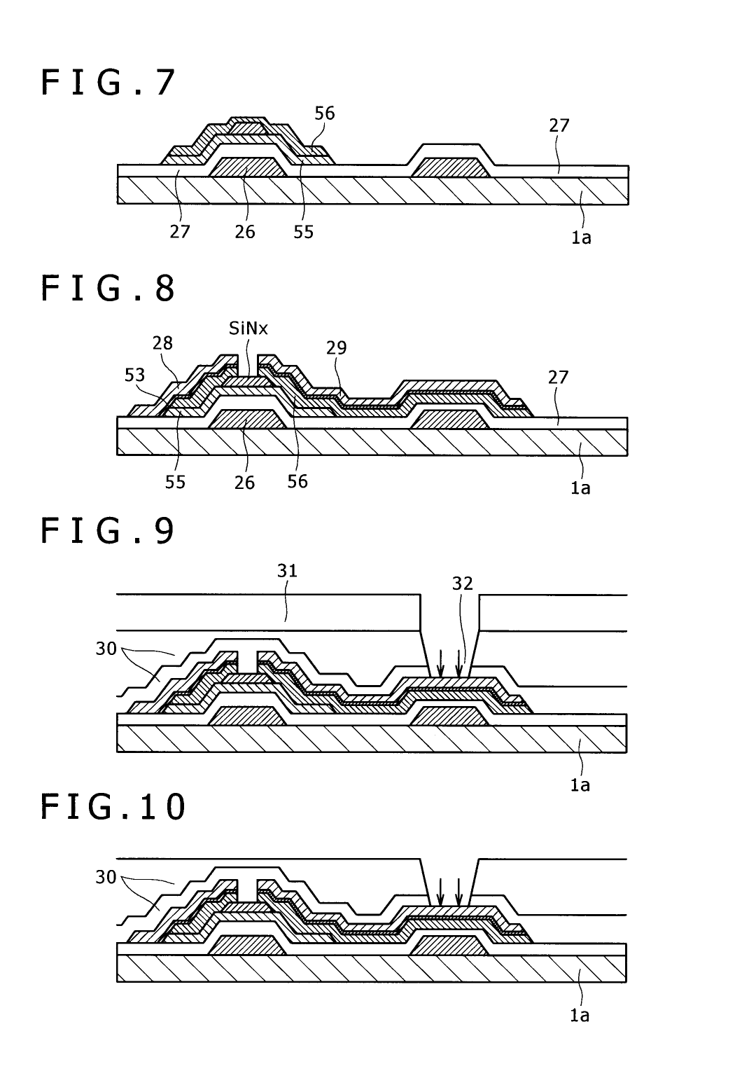

Subsequently, with rear side exposure using the gate electrode 26 as a mask, as shown in FIG. 6, the silicon nitride film (SiNx) is patterned to form a channel protective film. Further, thereon, phosphorus (P)-doped n⁺ type hydrogenated amorphous silicon film (n⁺a-Si—H) 56 with a thickness of about 50 nm is deposited. Then, as shown in FIG. 7, a hydrogenated amorphous silicon film (a-Si—H) 55 and an n⁺ type hydrogenated amorphous silicon film (n⁺a-Si—H) 56 are patterned.

Then, thereon, using a sputtering method, a Mo film 53 with a thickness of about 50 nm and Al-0.5 atomic percent Ni-0.35 atomic percent La alloy films 28 and 29 with a thickness of about 300 nm are sequentially deposited. The deposition temperature of sputtering is set at 250° C. Then, patterning is carried out as shown in FIG. 8. As a result, a source electrode 28 integral with a signal line and a drain electrode 29 to be directly connected to a pixel electrode 5 are formed. Further, by using the source electrode 28 and the drain electrode 29 as a mask, the N⁺ type hydrogenated amorphous silicon film (N⁺a-Si—H) 56 on the channel protective film (SiNx) is removed by dry etching.

Then, as shown in FIG. 9, by using, for example, a plasma CVD apparatus, a silicon nitride film 30 with a thickness of about 300 nm is deposited to form a protective film. The deposition temperature at this step is, for example, about 250° C. Then, on the silicon nitride film 30, a photoresist layer 31 is formed. Then, the silicon nitride film 30 is patterned. With, for example, dry etching, a contact hole 32 is formed in the silicon nitride film 30. Simultaneously, a contact hole (not shown) is formed in the portion serving for connection with the TAB on the gate electrode at the panel edge.

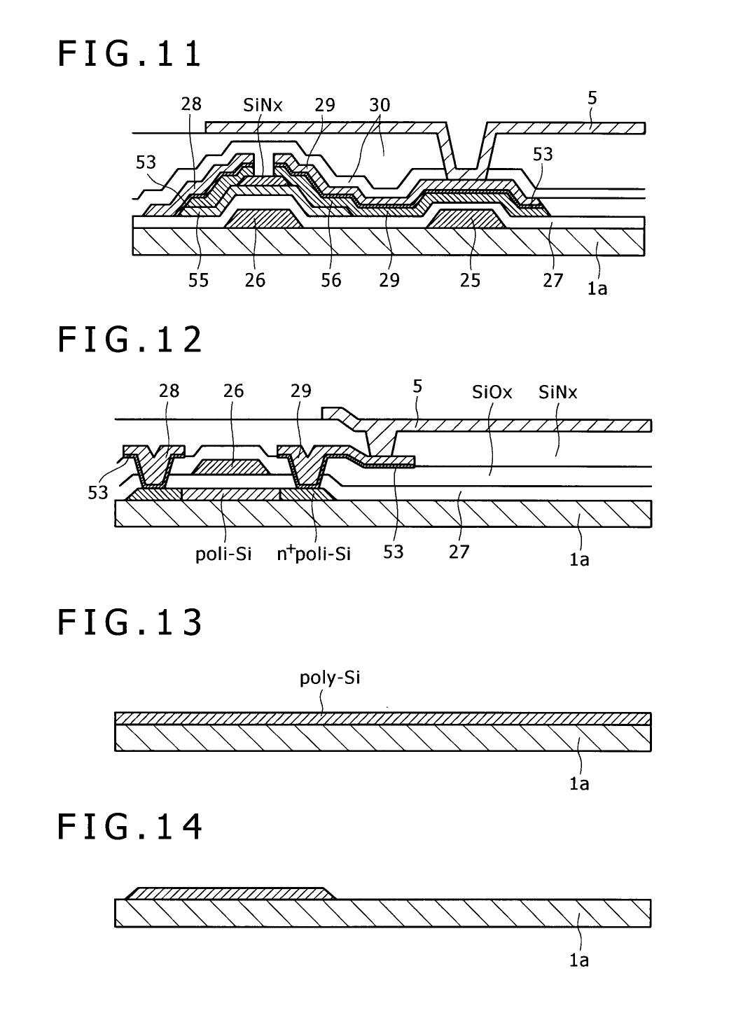

Then, for example, after going through an ashing step by oxygen plasma, as shown in FIG. 10, a photoresist layer 31 is released by using a releasing solution of, for example, amine type. Finally, for example, within the range of the storage time (about 8 hours), as shown in FIG. 11, for example, an ITO film with a thickness of about 40 nm is deposited, and patterning by wet etching is carried out. As a result, a transparent pixel electrode 5 is formed. Simultaneously, the ITO film is patterned for bonding with TAB at the connection portion of the gate electrode at the panel edge. As a result, a TFT array substrate 1 is completed.

In the TFT substrate thus manufactured, the drain electrode 29 and the transparent pixel electrode 5 are in direct contact with each other. Whereas, the gate electrode 26 and the ITO film for TAB connection are also in direct contact with each other.

In the foregoing description, as the transparent pixel electrodes 5, the ITO (indium tin oxide) film was used. However, a composite oxide containing at least one of indium oxide, zinc oxide, tin oxide, and titanium oxide may also be used. For example, an IZO film (InOx-ZnOx type oxide transparent conductive film) can also be used. Whereas, as an active semiconductor layer, polysilicon may be used in place of amorphous silicon (see Embodiment 2 described later).

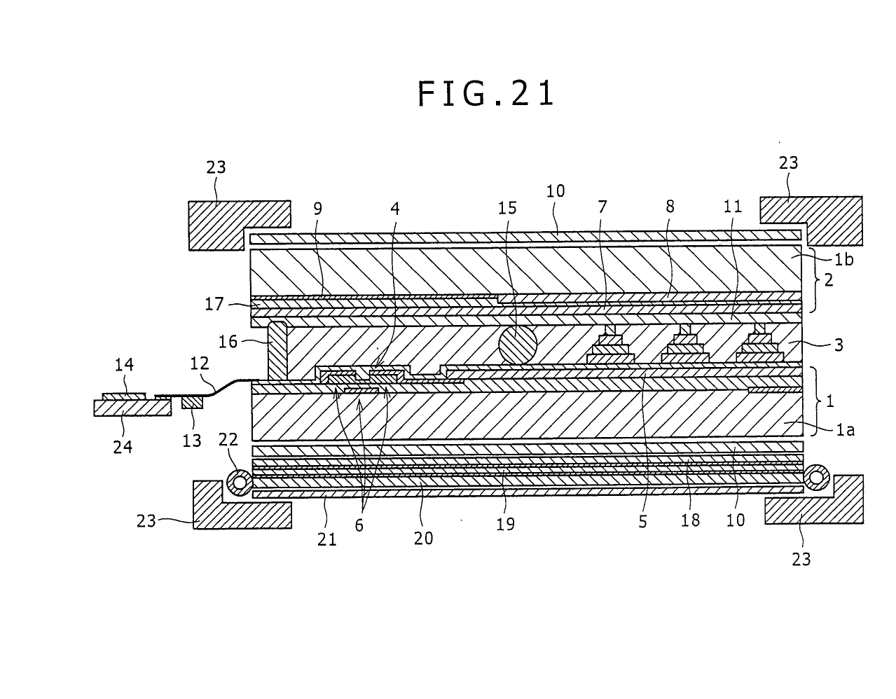

By using the TFT substrate thus obtained, a liquid crystal display apparatus shown in FIG. 21 is completed with, for example, the method described below.

First, on the surface of the TFT substrate 1 manufactured in the foregoing manner, for example, polyimide is applied, and dried, and then, subjected to a rubbing treatment, thereby to form an alignment film.

On the other hand, for an opposing substrate 2, on a glass substrate, for example, chromium (Cr) is patterned in a matrix, thereby to form a light shielding film 9. Then, in the gaps in the light shielding film 9, red, green, and blue color filters 8 made of a resin are formed. On the light shielding film 9 and the color filters 8, a transparent conductive film such as an ITO film is arranged as a common electrode 7. As a result, an opposing electrode is formed. Then, on the uppermost layer of the opposing electrode, for example, polyimide is applied, and dried and then, subjected to a rubbing treatment, thereby to form an alignment film 11.

Then, the TFT substrate 1 and the side of the opposing substrate 2 on which the alignment film 11 is formed are arranged so as to oppose each other. With a sealing material 16 made of a resin, or the like, the TFT substrate 1 and the opposing substrate 2 are bonded to each other except for the injection opening of a liquid crystal. At this step, a spacer 15 is interposed between the TFT substrate 1 and the opposing substrate 2. By this and other means, the gap between the two substrates is maintained roughly constant.

The void cell thus obtained is placed in vacuum. Thus, the pressure is gradually returned to atmospheric pressure with the injection opening immersed in a liquid crystal. As a result, a liquid crystal material containing liquid crystal molecules is injected to the void cell to form a liquid crystal layer. Thus, the injection opening is sealed. Finally, on outer opposite sides of the void cell, polarizing plates 10 are bonded to complete a liquid crystal display apparatus.

Then, as shown in FIG. 21, a driver circuit 13 for driving the liquid crystal display apparatus is electrically connected to the liquid crystal display apparatus, and disposed at the side part or the rear side part of the liquid crystal display apparatus. Then, by a holding frame 23 including an opening serving as the display side of the liquid crystal display apparatus, a backlight 22 serving as a surface light source, a light guide plate 20, and a holding frame 23, the liquid crystal display apparatus is held. Thus, the liquid crystal display apparatus is completed.

### Embodiment 2

By reference to FIG. 12, an embodiment of a polysilicon TFT substrate will be described in details.

FIG. 12 is a schematic cross sectional explanatory view illustrating a preferred embodiment of a top gate type TFT substrate in accordance with the present invention.

This embodiment is mainly different from Embodiment 1 described above in the following points: As an active semiconductor layer, polysilicon is used in place of amorphous silicon; not a bottom gate type but a top gate type TFT substrate is used; and not as a wiring material for the source-drain electrode and the gate electrode, but as a wiring material for a source-drain electrode, an Al-0.2 atomic percent Ag-0.35 atomic percent La alloy satisfying the requirements of the present invention is used. Specifically, the polysilicon TFT substrate of this embodiment shown in FIG. 12 is different from the amorphous silicon TFT substrate shown in FIG. 3 in the following point: the active semiconductor film is formed of a polysilicon film (poly-Si) not doped with phosphorus and a polysilicon film (n⁺ poly-Si) ion implanted with phosphorus or arsenic (As). Whereas, the signal line is formed in such a manner as to cross with the scanning line via the interlayer insulation film (SiOx).

The following has been experimentally confirmed. In accordance with this embodiment, without a barrier metal layer interposed as in the related art, the material for use in the drain electrode 29 of the TFT can be directly connected with the transparent pixel electrode 5. This can also implement favorable TFT characteristics comparable to or better than those of a conventional TFT substrate.

In this embodiment, when the alloy described above is applied to the material for the scanning line, the barrier metal layers 51 and 52 can be omitted. It has been confirmed that this configuration can also implement favorable TFT characteristics comparable to or better than those of a conventional TFT substrate.

Then, by reference to FIGS. 13 to 19, a description will be given to one example of a method for manufacturing a polysilicon TFT substrate in accordance with the present invention shown in FIG. 12. Herein, as a material for a source-drain electrode and a wiring thereof, an Al-0.2 atomic percent Ag-0.35 atomic percent La alloy is used. The thin film transistor is a polysilicon TFT using a polysilicon film (poly-Si) as a semiconductor layer. Throughout FIGS. 13 to 19, the same reference numerals and signs as in FIG. 12 are given.

First, on a glass substrate 1a, for example, with a plasma CVD method, at a substrate temperature of about 300° C., a silicon nitride film (SiNx) with a thickness of about 50 nm, a silicon oxide film (SiOx) with a thickness of about 100 nm, and a hydrogenated amorphous silicon film (a-Si—H) with a thickness of about 50 nm are deposited. Then, in order to transform the hydrogenated amorphous silicon film (a-Si—H) into polysilicon, a heat treatment (at about 470° C. for about 1 hour) and laser annealing are carried out. After carrying out a dehydrogenation treatment, for example, with an excimer laser annealing apparatus, a laser with an energy of about 230 mJ/cm² is applied to the hydrogenated amorphous silicon film (a-Si—H). This results in a polysilicon film (poly-Si) with a thickness of about 0.3 μm (FIG. 13).

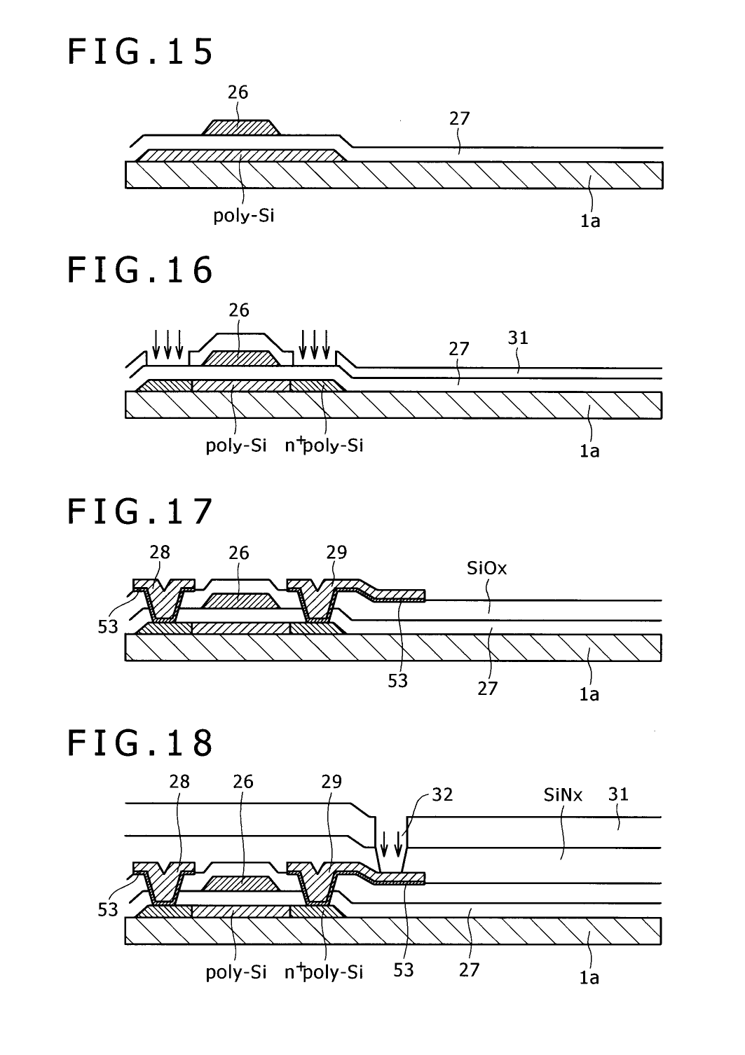

Then, as shown in FIG. 14, the polysilicon film (poly-Si) is patterned by plasma etching or the like. Then, as shown in FIG. 15, a silicon oxide film (SiOx) with a thickness of about 100 nm is deposited to form a gate insulation film 27. On the gate insulation film 27, by sputtering or the like, an Al-0.2 atomic percent Ag-0.35 atomic percent La alloy film with a thickness of about 200 nm is deposited. Then, pattering is carried out with a method such as wet etching. As a result, a gate electrode 26 serving as a scanning line is formed.

Subsequently, as shown in FIG. 16, a mask is formed with a photoresist 31. With, for example, an ion implantation apparatus, for example, phosphorus is doped in an amount of 1×10¹⁵ atoms/cm² at about 50 keV. As a result, in a part of the polysilicon film (poly-Si), an n⁺ type polysilicon film (n⁺ poly-Si) is formed. Then, the photoresist 31 is released off therefrom, and a heat treatment is carried out at, for example, about 500° C., thereby to diffuse phosphorus.

Then, as shown in FIG. 17, with, for example, a plasma CVD apparatus, a silicon oxide film (SiOx) with a thickness of about 500 nm is deposited at a substrate temperature of about 250° C. to form an interlayer insulation film. Then, similarly, by using a mask patterned by a photoresist, the interlayer insulation film (SiOx) and the silicon oxide film of the gate insulation film 27 are dry etched to form contact holes. With sputtering, a Mo film 53 with a thickness of about 50 nm and an Al-0.2 atomic percent Ag-0.35 atomic percent La alloy film with a thickness of about 450 nm are deposited, followed by patterning. This results in the formation of a source electrode 28 and a drain electrode 29 integral with a signal line. As a result, the source electrode 28 and the drain electrode 29 are contacted with the n⁺ type polysilicon film (n⁺ poly-Si) via the Mo film 53 through respective contact holes.

Then, as shown in FIG. 18, with a plasma CVD apparatus or the like, a silicon nitride film (SiNx) with a thickness of about 300 nm is deposited at a substrate temperature of about 250° C. to form an interlayer insulation film. On the interlayer insulation film, a photoresist layer 31 is formed. Then, a silicon nitride film (SiNx) is patterned, and a contact hole 32 is formed in the silicon nitride film (SiNx) by, for example, dry etching.

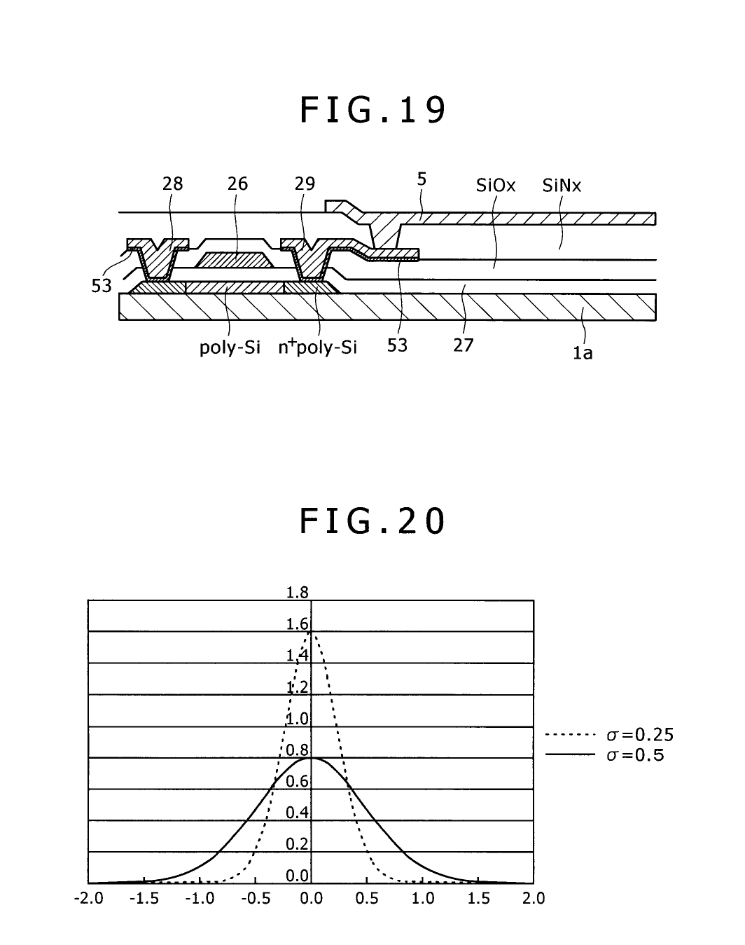

Then, as shown in FIG. 19, for example, after going through an ashing step by oxygen plasma, in the same manner as in Embodiment 1 described above, the photoresist is released by using an amine type releasing solution or the like. Then, an ITO film is deposited, and patterning by wet etching is carried out to form a pixel electrode 5.

In the polysilicon TFT substrate manufactured in this manner, the drain electrode 29 is in direct contact with the ITO transparent pixel electrode 5. At the interface between the Al-0.2 atomic percent Ag-0.35 atomic percent La alloy film forming the drain electrode 29 and the pixel electrode 5, an Ag precipitate is formed. At the same time, recrystallization of Al is promoted. This also largely reduces the electric resistivity of the Al alloy.

Then, in order to stabilize the characteristics of the transistor, for example, a heat treatment is carried at about 250° C. for about 1 hour. As a result, a polysilicon TFT array substrate is completed.

With the TFT substrate in accordance with Embodiment 2, and a liquid crystal display apparatus including the TFT substrate, it is possible to obtain the same effects as with the TFT substrate in accordance with the first embodiment described above. Further, the Al alloy in the second embodiment can also be used as a reflection electrode of a reflection type liquid crystal display apparatus.

By using the TFT array substrate obtained in this manner, a liquid crystal display apparatus is completed in the same manner as with the TFT substrate of Embodiment 1 described above.

### EXAMPLES

Below, the present invention will be more specifically described by way of examples. However, the present invention is not limited by the following examples at all. The present invention is capable of being practiced with changes properly made within the range applicable to the foregoing and following gists. All of them are included in the technical scope of the present invention.

### Example 1

### [I] Manufacturing of Test Sample

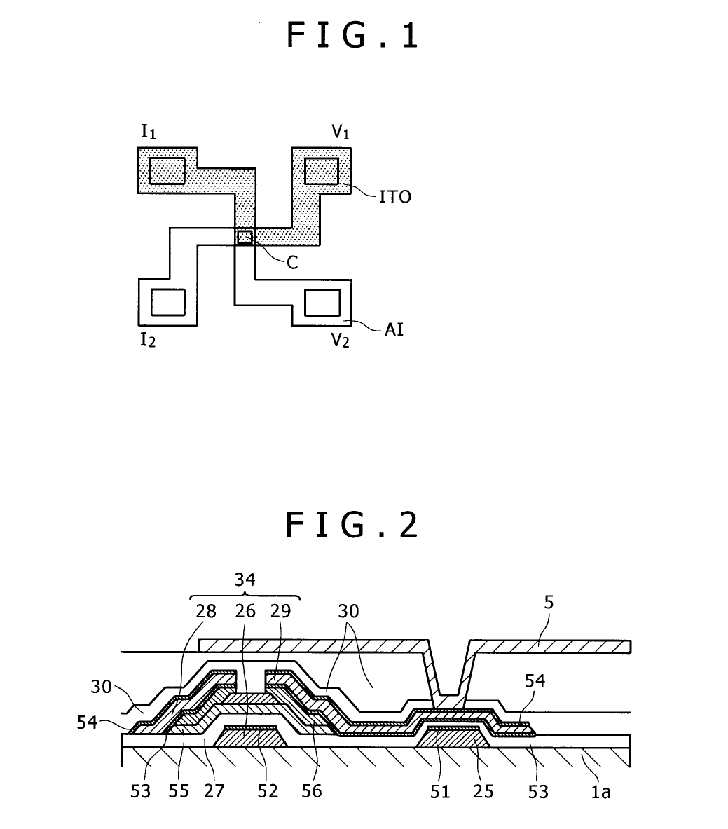

In order to examine the contact electric resistance between the ITO film and the Al alloy film, the Kelvin pattern shown in FIG. 1 was manufactured as a test sample of the present invention (the inventive sample). The method for manufacturing the Kelvin pattern is as shown in the following items (1) to (5). In Example 1, an Al-0.5 atomic percent Ni alloy film containing Ni in an amount of 0.5 atomic percent was used. Whereas, the content of the alloy elements of the Al alloy film was determined by an ICP atomic emission spectrometry (Inductively Coupled Plasma atomic emission spectrometry) (the same also applies to Example 2 described later).

(1) First, a non alkali glass (#1737 manufactured by Corning Co.) was used as a substrate. The substrate was heated to 250° C. (the precipitation temperature of Ni shown in Table 1 or higher). Then, by a sputtering method, an Al-0.5 atomic percent Ni alloy film with a thickness of 300 nm was formed. The sputtering conditions were as follows.

Sputtering gas: Ar, Sputtering pressure: 3 mTorr

(2) Then, patterning with a photolithography method was carried out. Then, with a CVD method, an insulation film (SiN) with a thickness of 300 nm was deposited.

(3) Then, with a photolithography method, 80 μM square contact holes are patterned. Then, dry etching (RIE) by reactive plasma was carried out under the following conditions, thereby to form contact holes. By this etching process, the about 10-nm thick Al alloy film from the outermost layer was removed.

Etching gas: argon/oxygen/sulfur hexafluoride mixed gas

Etching time: 60 seconds

In order to etch both the insulation film and the Al alloy film, 100% overetching on a time basis was carried out in addition to the etching time of the insulation film.

(4) Subsequently, after going through an ashing step by an oxygen plasma, the film was washed at 100° C. for 5 minutes by using an amine type releasing solution (“releasing solution 106” manufactured by TOKYO OHKA KOGYO Co., Ltd.) to release the photoresist. As a result, contaminants such as fluorides, oxides, and carbon formed on the surface layer of the Al alloy film (thickness of about several nanometers) were removed.

(5) Then, an ITO film (indium tin oxide prepared by adding 10 mass % tin oxide to indium oxide) with a thickness of about 200 nm was deposited by a sputtering method. Then, patterning was carried out with a photolithography method, resulting in an inventive sample.

### [II] Preparation of Reference Sample

For comparison, a reference sample subjected to a post heat treatment after deposition of the Al alloy film as with in the JP-A-2004-214606 was manufactured.

Specifically, a reference sample was manufactured in the same manner as with the manufacturing method of the inventive sample, except that in the step (1) of the manufacturing method of the inventive sample described above, by setting the substrate temperature at room temperature, a 300 nm thick Al-0.5 atomic percent Ni alloy film was formed with a sputtering method, followed by a heat treatment at a temperature of 150° C. for 15 to 60 minutes.

### [III] Measurement of Contact Electric Resistance

By the use of the Kelvin pattern (contact hole size: 80 μm square) shown in FIG. 1, and by means of a manual prober and a semiconductor parameter analyzer “HP4156A” (manufactured by Hewlett-Packard Co.), the contact electric resistance between the Al alloy film and the ITO film was measured with a four-probe method. With the four-probe method, an electric current is caused to flow through the ITO-Al alloy. With other probes, the voltage drop across ITO-Al alloy was measured. Specifically, an electric current I am caused to flow across I₁-I₂ of FIG. 1, and the voltage V across V₁-V₂ was monitored. As a result, the contact electric resistance R of the contact portion C was determined as [R=(V₁−V₂)/I₂].

### [IV] Measurement of Variance Coefficient σ and Average Value of Contact Electric Resistance

With the foregoing method, 100 inventive samples and 100 reference samples were manufactured. Based on the foregoing method, the contact electric resistance was measured. Then, based on the foregoing formula (I), each variance coefficient σ of the contact electric resistance of 100 inventive samples and 100 reference samples was calculated.

FIG. 20 shows respective Gaussian distribution (normal distribution) curves of the samples.

As shown in FIG. 20, the variance coefficient σ of the contact electric resistance of the inventive samples manufactured by the method of the present invention is as small as 0.25. It shows less variation as compared with the reference samples (the variance coefficient of the contact electric resistance 0.5) manufactured with a conventional method. It has been shown that this results in a stable contact electric resistance. Whereas, the average value of the contact electric resistances of the inventive samples is 150 Ω·cm, which has been controlled lower as compared with the reference samples (the average value of the contact electric resistances 250 Ω·cm).

Therefore, the following has been observed. The use of the method of the present invention can provide a display apparatus showing a contact electric resistance lower and more suppressed in variations than ever.

### Example 2

In this example, Al alloys of various compositions shown in Table 2 were used, and the transparent oxide conductive film was ITO. Under such conditions, 100 inventive samples and 100 reference samples were manufactured in the same manner as in Example 1. Thus, the variance coefficients σ of the contact electric resistances were calculated. These results are shown in Table 2 together. In Table 2, the average value of the contact electric resistances of the inventive samples is shown as the relative value when the average value of the contact electric resistances of the reference samples is taken as 1. In Table 2, the results of the Example 1 (Ni=0.5 atomic percent) described above are also shown together.

TABLE 2

| | | Inventive Sample | | |
|---|---|---|---|---|
| | | | Relative value | |
| | | | when the average | Reference Sample |
| Alloy Element | | Variance | value of contact | Variance |
| | Content | coefficient | resistances of | coefficient |
| | (atomic | σ of contact | reference samples | σ of contact |
| Type | percent) | resistance | is taken as 1 | resistance |
| Ag | 0.5 | 0.24 | 0.72 | 0.58 |
| Ag | 0.3 | 0.18 | 0.85 | 0.60 |
| Ag | 0.2 | 0.32 | 0.68 | 0.58 |
| Ag | 0.1 | 0.35 | 0.53 | 0.88 |
| Ag | 2.0 | 0.08 | 0.72 | 0.12 |
| Zn | 0.5 | 0.33 | 0.65 | 0.54 |
| Zn | 0.3 | 0.44 | 0.80 | 0.60 |
| Zn | 0.2 | 0.46 | 0.52 | 0.63 |
| Zn | 0.1 | 0.30 | 0.53 | 0.81 |
| Zn | 2.0 | 0.20 | 0.75 | 0.24 |
| Cu | 0.5 | 0.29 | 0.66 | 0.71 |
| Cu | 0.3 | 0.22 | 0.64 | 0.60 |
| Cu | 0.2 | 0.37 | 0.60 | 0.55 |
| Cu | 0.1 | 0.44 | 0.75 | 0.67 |
| Cu | 2.0 | 0.22 | 0.89 | 0.27 |
| Ni | 0.5 | 0.25 | 0.60 | 0.51 |
| Ni | 0.3 | 0.25 | 0.60 | 0.60 |
| Ni | 0.2 | 0.42 | 0.59 | 0.60 |
| Ni | 0.1 | 0.40 | 0.68 | 0.85 |
| Ni | 2.0 | 0.10 | 0.71 | 0.12 |

First, consideration will be given to Ni.

As shown in Table 2, when the inventive samples (the amount of the alloy elements added≦0.5 atomic percent) are used, the average value of the contact electric resistances becomes smaller, and the variations in contact electric resistance can also be controlled to a narrower range (specifically, variance coefficient σ≦0.5) as compared with the reference samples manufactured with a conventional method.

For example, when Ni content=0.3 atomic percent, the variance coefficient σ of the contact electric resistance of the inventive sample is 0.25, which is smaller as compared with the reference samples (the variance coefficient σ of the contact electric resistance=0.6). Whereas, it was possible to control the average value of the contact electric resistances of the inventive samples to 0.5 or less.

The same tendency as described above was observed in both cases where Ni content=0.2 atomic percent, and 0.1 atomic percent.

Incidentally, in Table 2, for reference, the results when an Al alloy film in which Ni content=2, which exceeds the upper limit (0.5 atomic percent) of the alloy element content defined in the present invention, is used are also shown. This is done for proving the following: the effect of the present invention (control of variations in contact electric resistance) is noticeably observed especially when the alloy element content has been remarkably reduced as with the present invention.

Namely, the following was observed. In the case of a Ni content of 2 atomic percent, even when either of the inventive sample or the reference sample is used, it was possible to control the variations in contact electric resistance to a narrow range (σ of the inventive sample=0.10, σ of the reference sample=0.12). However, a priority is given to the reduction of the electric resistivity of the Al alloy as in the present invention, and the upper limit of the Ni content is controlled to as low as 0.5 atomic percent. Then, the variations in contact electric resistance also tend to roughly increase with a decrease in alloy element content.

The same tendency as Ni was also observed when other alloy elements (Ag, Cu, and Zn) were used.

Further, an experiment was carried out in the same manner as described above, except that IZO was used in place of the ITO described above as the transparent oxide conductive film. The results are shown in Table 3.

TABLE 3

| | | Inventive Sample | | |
|---|---|---|---|---|
| | | | Relative value | |
| | | | when the average | Reference Sample |
| Alloy Element | | Variance | value of contact | Variance |
| | Content | coefficient | resistances of | coefficient |
| | (atomic | σ of contact | reference samples | σ of contact |
| Type | percent) | resistance | is taken as 1 | resistance |
| Ag | 0.5 | 0.22 | 0.66 | 0.62 |
| Ag | 0.1 | 0.35 | 0.71 | 0.75 |
| Ag | 2.0 | 0.12 | 0.59 | 0.1 |
| Zn | 0.5 | 0.46 | 0.53 | 0.62 |
| Zn | 0.1 | 0.39 | 0.66 | 0.71 |
| Zn | 2.0 | 0.31 | 0.66 | 0.31 |
| Cu | 0.5 | 0.35 | 0.7 | 0.61 |
| Cu | 0.1 | 0.45 | 0.81 | 0.65 |
| Cu | 2.0 | 0.35 | 0.73 | 0.29 |
| Ni | 0.5 | 0.25 | 0.61 | 0.55 |
| Ni | 0.1 | 0.44 | 0.69 | 0.76 |
| Ni | 2.0 | 0.10 | 0.71 | 0.12 |

As shown in Table 3, also when IZO was used, the experimental results showing the same tendency as described above were obtained.

What is claimed is:

1. A method for manufacturing a display apparatus having a structure in which a transparent oxide conductive film and an Al alloy film are in direct contact with each other on a substrate,
the Al alloy film containing at least one alloy element selected from a group consisting of Ag, Zn, Cu, and Ni in an amount of 0.5 atomic percent or less,
the method, comprising: controlling the temperature of the substrate to the precipitation temperature of the alloy element or higher, and forming the Al alloy film.

2. The manufacturing method according to claim 1, wherein the alloy element is Ni, and the temperature of the substrate is controlled to 250° C. or higher.

3. A display apparatus comprising
a substrate;
a transparent oxide conductive film; and
an Al alloy film,
the transparent oxide conductive film being in direct contact with Al alloy film on the substrate,
wherein:
the Al alloy film contains at least one alloy element selected from a group consisting of Ag, Zn, Cu, and Ni in an amount of 0.5 atomic percent or less; and
when the variance of the contact electric resistance between the transparent oxide conductive film and the Al alloy film is approximated by the Gaussian distribution based on 100 samples obtained from the display apparatus, the variance coefficient σ is 0.5 or less.

4. The display apparatus according to claim 3, wherein the Al alloy film is a component of a scanning line of a thin film transistor.

5. The display apparatus according to claim 3, wherein the Al alloy film is a component of a drain electrode of a thin film transistor.
